(19) United States
(12) Patent Application Publication
(10) Pub. No.: US 2004/0049501 A1
(43) Pub. Date: Mar. 11, 2004

(54) Data management apparatus and data management program

(75) Inventor: Takatoshi Mochizuki, Kobe-Shi (JP)

Correspondence Address: BURNS DOANE SWECKER & MATHIS L L P, POST OFFICE BOX 1404, ALEXANDRIA, VA, 22313-1404, US

(73) Assignee: MINOLTA CO., LTD.

(21) Appl. No.: 10/657,260

(22) Filed: Sep. 9, 2003

(30) Foreign Application Priority Data
Sep. 10, 2002 (JP) 2002-264055

(51) Int. Cl. G06F 7/00

(52) U.S. Cl. 707/3

(57) ABSTRACT

When a new data file is received from the interface, the data management apparatus stores it in the storage unit. When an instruction to move the new data file to a folder is entered by the user via the input unit, the keywords assigned to the existing data files in the folder are extracted. The extracted keywords are then assigned to the new data file as its keywords.

The present application claims priority to Japanese Patent Application No. 2002-264055 filed Sep. 10, 2002, the entire content of which is hereby incorporated by reference.

### BACKGROUND OF THE INVENTION

1. Field of the Invention

The present invention relates to data management in which data files are managed based on keywords specified for each file.

2. Description of the Related Art

Remarkable advancement has been seen in the area of information processing in recent years, and in particular, the performance level of personal computers and the like has improved dramatically. With this as a backdrop, information processing apparatuses such as image database apparatuses and electronic filing apparatuses, which incorporate image or text data via an input apparatus, store and manage such data, and perform searches for and print out via an output apparatus such data as necessary, are becoming increasingly popular not only for business and special purposes but also among general users.

In order to facilitate data searches in these information processing apparatuses, additional information used for search purposes is generally input together with the data when it is entered. By increasing the types of such additional information, various types of searches become possible, and search efficiency increases. However, where the types of additional information increase, both the number of steps involved in the input process and the complexity of the operation increase during data entry, and where the number of data sets to register is large, an increased amount of work is required of the user.

An example of such additional information comprises attribute information that constitutes information essential for data management. Attribute information includes information regarding the date on which the data file was created or revised, the file name, the file format, etc. Such attribute information is already automatically added to the data file in a wide range of apparatuses.

Alternatively, keywords, which constitute additional information, may be devised and entered by the user, or appropriate keywords may be selected and added to the data file from among a large number of keywords registered in a keyword dictionary or the like (see Japanese Laid-Open Patent Application H10-326278). There is also a technology in which keywords are ‘guessed’ based on the amounts of certain characteristics (such as the hue, brightness and shape of the elements included in the image) of the image data (see Japanese Laid-Open Patent Application H10-326278).

A technology for automatic addition of keywords to a data file based on prescribed items of information regarding that file is also under consideration. Specifically, the technology extracts words included in the text and adds them to the file as keywords (Japanese Laid-Open Patent Application H10-312387).

However, such conventional methods are not completely capable of adding keywords in an effective way, because they involve the following problem, i.e., the user must select or specify the keywords himself, which is a burdensome task for the user. In the case of the technology that extracts the amounts of various characteristics regarding the image data, because the keywords for the image data are ‘guessed’, words that have little relevance to the file may be selected as keywords. In other words, the keyword accuracy is not constant. The same goes true for the technology that extracts words included in the text as keywords.

Consequently, the user can only assign data files to folders for management purposes without adding keywords thereto, which prevents the performance of effective file management.

### SUMMARY OF THE INVENTION

A main object of the present invention is to add keywords to data files automatically and effectively.

In order to attain this and other objects, according to an aspect of the present invention, a data management apparatus that manages data files is composed of a storage unit that stores folders, data files and keywords assigned to each data file, an input unit by which the user enters an instruction to move a new data file to a folder, and a processing unit that extracts the keywords assigned to the existing data files in that folder and assigns them to the new data file in response to the instruction.

It is acceptable if the processing unit extracts keywords only from existing data files having the same extension as the new data file.

It is acceptable if the processing unit extracts only keywords that are assigned to the highest number of existing data files.

The invention itself, together with further objects and attendant advantages, will best be understood by reference to the following detailed description taken in conjunction with the accompanying drawings.

### BRIEF DESCRIPTION OF THE DRAWINGS

FIG. 1 is a drawing showing an example of the construction of an information processing system that is used to describe an embodiment of the present invention;

FIG. 2 is a block diagram showing the construction of a data management apparatus 20;

FIG. 3 is a flow chart showing the main operations performed by the data management apparatus 20 in the information processing system (FIG. 1);

FIG. 4 is a flow chart showing the sequence of data registration processes; and

FIG. 5 is a flow chart showing the sequence of data registration processes when a different keyword extraction procedure is used.

In the following description, like parts are designated by like reference numbers throughout the several drawings.

### DETAILED DESCRIPTION OF THE PREFERRED EMBODIMENTS

An embodiment of the present invention is described below with reference to the accompanying drawings.

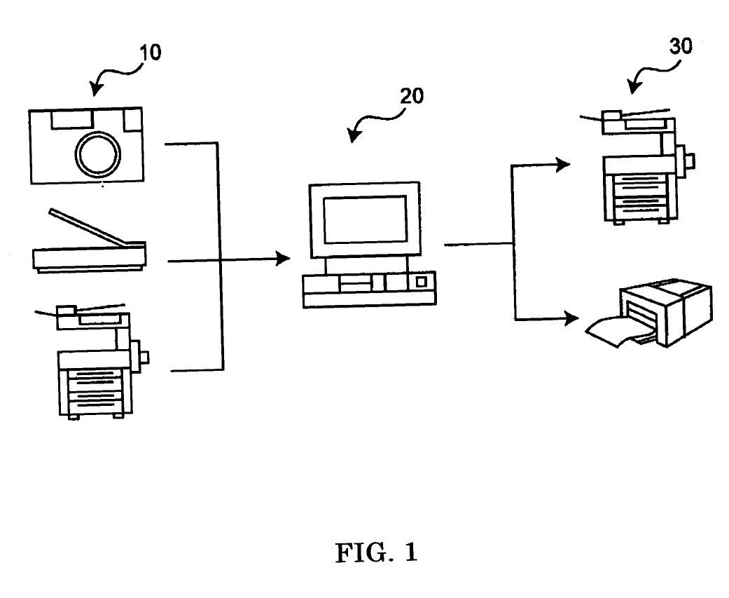

FIG. 1 is a drawing showing an example of the construction of an information processing system used in the description of this embodiment. This system comprises a data file input apparatus 10 that inputs data files containing such data as image data or text data, a data management apparatus 20 that manages the data files input by the data file input apparatus 10, and a printer 30 that prints out the data files.

The system is characterized in that the data management apparatus 20 automatically assigns keywords to each data file input by the data file input apparatus 10. A ‘keyword’ is a description that characterizes the contents of the data file. When the user assigns a data file to a prescribed folder, the data management apparatus 20 selects appropriate keywords from among the keywords for the other data files that already exist in that folder, and automatically adds them to the data file. This data management apparatus 20 comprises a general-purpose PC, for example, but is not limited to PCs so long as it is implemented by an apparatus that has the construction described below and is capable of performing the processing described below. Where the data files handled constitute image/text files, the data management apparatus 20 comprises an image/text management apparatus.

Where the data file is an image data file, the data file input apparatus 10 comprises a digital camera, flatbed scanner, film scanner or other similar device. The data file input apparatus 10 may also comprise a flexible/CD/DVD drive or the like. Data files may be input to the data management apparatus 20 from other apparatuses over a network (not shown). The printer 30 is a public-domain printer. The data file input apparatus 10 and the printer 30 may comprise a single multi-functional peripheral (MFP) that has the multiple functions of a scanner, printer, copying machine and facsimile.

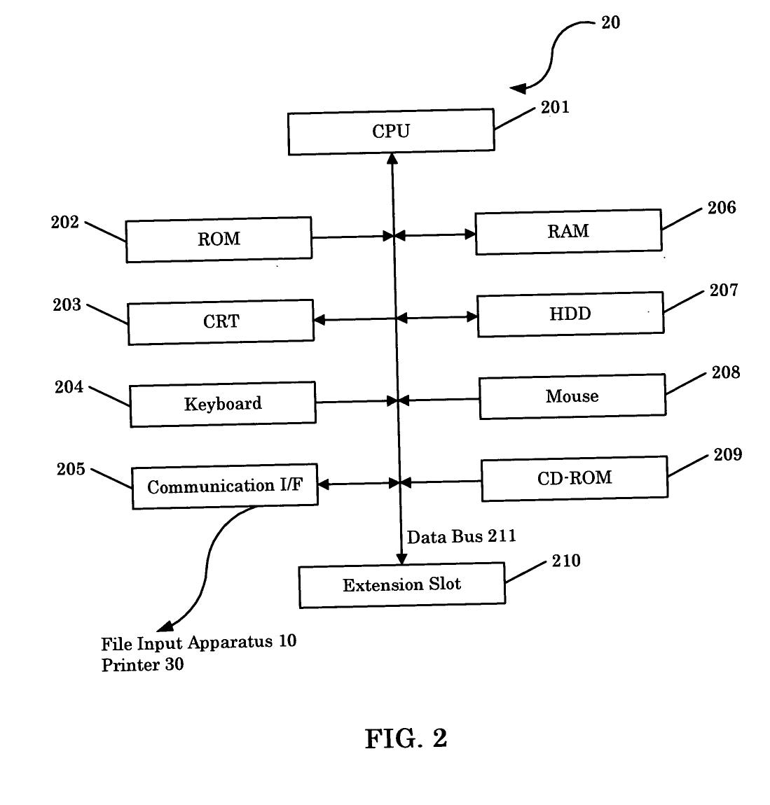

FIG. 2 is a block diagram showing the construction of the data management apparatus 20. The data management apparatus 20 includes a central processing unit (CPU) 201, a read-only memory (ROM) 202, a display (CRT) 203, a keyboard 204, a communication interface (I/F) 205, a random access memory (RAM) 206, a hard disk memory (HDD) 207, a mouse 208, a CD-ROM 209, and an extension slot 210, which can mutually input and output data via a data bus 211.

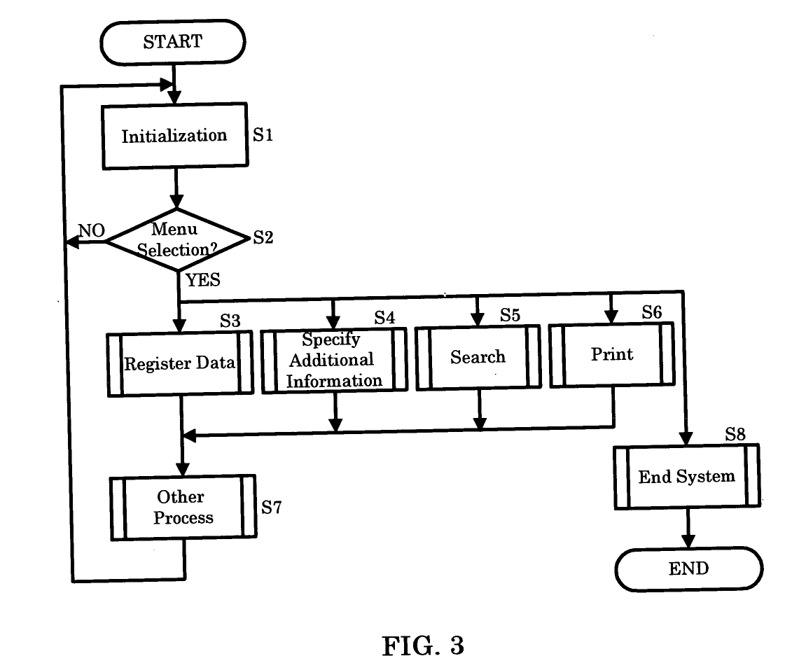

The CPU 201 is a Pentium® from Intel, Inc., and controls the information processing system based on programs stored in the ROM 202. The CPU 201 sends commands via the data bus 211, and controls the overall operation of the data management apparatus 20. The main operations performed by the data management apparatus 20 under the control by the CPU 201 are explained below with reference to FIGS. 3-5.

The CRT 203 is a display that displays images, characters, and the like, as well as prompts or instructs the user to perform operations, and includes a display control circuit. The keyboard 204 receives input of numbers and/or characters from the user and transfers them to the CPU 201. The keyboard 204 is also used when setting search parameters or the like when assigning additional information described below. The communication I/F 205 is an interface by which the data management apparatus 20 receives and sends data to and from the data file input apparatus 10 and printer 30 (FIG. 1). The RAM 206 is a memory that stores data and programs executed by the CPU 201, which may be accessed at any time.

The HDD 207 is a large-capacity secondary storage device, and stores data files including image and text data files, as well as a file system in which data files are stored in folders for management purposes. The mouse 208 receives pointer position information and sends it to the CPU 201. It is also used by the user to select a file and move it to a prescribed folder, for example. The CD-ROM 209 is a drive device capable of replaying CD-ROMs, and sends the data therefrom to the CPU 201. The extension slot 210 is a slot by which to add a circuit board or the like that expands the functioning of the data management apparatus 20. The keyboard 204 and mouse 208 are sufficient so long as they function as instruction input means by which the user enters instructions. If this function can be realized, the keyboard and mouse need not constitute separate devices. Alternatively, a completely different substitute instruction input means may be used instead.

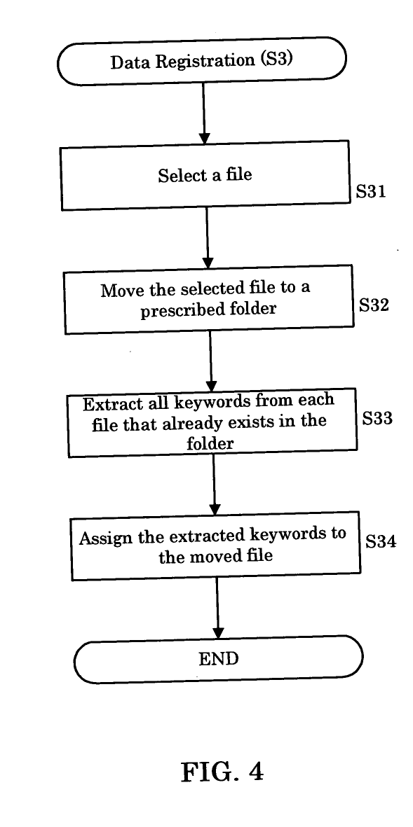

FIG. 3 is a flow chart showing the main operations performed by the data management apparatus 20 of the information processing system (FIG. 1). The CPU 201 (FIG. 2) operates in accordance with a computer program based on this flow chart. Specifically, when the system is turned ON and the program is booted, the CPU 201 first performs an initialization process in which flags and other components necessary to perform the steps below are initialized, an initialization screen is displayed, etc. (step S1). It then displays the initialization menu on the CRT 203 (FIG. 2), and determines whether or not a process selection has been made via the initial menu screen (step S2). A menu comprises a list of processes that may be performed by the data management apparatus 20. In this Specification, the menu items consist of ‘Register data’, ‘Specify additional information’, ‘Search’, ‘Print’, and ‘End system’. The user selects a menu item using the keyboard 204 or mouse 208. This step is repeated until a menu item is selected. Once a menu item is selected, processing (S3-S6, S8) is performed accordingly.

Where ‘Register data’ is selected, the CPU 201 advances to step S3, which constitutes a main operation of the present invention. Data registration is a process whereby when a data file is moved to a prescribed folder, keywords are automatically added to that data file. The data management apparatus 20 extracts keywords from other data files already existing in the destination folder, selects appropriate keywords therefrom, and adds such keywords to the data file. This process is described with reference to FIG. 4.

Where ‘Specify additional information’ is selected, the CPU 201 advances to step S4. This step (step S4) is a process in which keywords, markers or the like that are used for search purposes are added to the data file in the data management apparatus 20. As described in the Description of the Related Art of this Specification, such additional information may constitute attribute information that is essential for data management. Attribute information includes information regarding the date on which the data was created or revised, the file name and the file format. In general, this attribute information has already been added automatically to the data file. In addition, apparatuses or methods that calculate colors from the color data for the image data and automatically add such color information to the image data file also exist in the public domain. Specification of additional information may be carried out automatically by the data management apparatus 20 or manually via input by the user.

Where ‘Search’ is selected, the CPU 201 advances to step S5. In the search process (step S5), the user enters a search word using the keyboard 204 or the like (FIG. 2), and the data management apparatus 20 searches for files for which the search word is included in the keywords or markers added to the files.

Where ‘Print’ is selected, the CPU 201 advances to step S6. In the printing process (step S6), the data management apparatus 20 sends a data file (text data or image data) specified by the user to the printer 30 (FIG. 1) based on the user's print instructions, and the data is printed.

Where ‘End system’ is selected, the CPU 201 advances to step S8. In this process (step S8), the data management apparatus 20 performs processing in order to turn itself OFF after the completion of data registration or printing, for example.

When data registration (step S3), specification of additional information (step S4), searching (step S5) or printing (step S6) is completed, the CPU 201 advances to other processes (step S7) to perform tail-end processing, and returns once more to the step in which it waits for selection of a menu item (step S2).

Data registration (step S3) will now be explained in detail with reference to FIG. 4. FIG. 4 is a flow chart showing the sequence of the processes involved in data registration. As described above, this is a process in which keywords are automatically assigned to a data file when the data file is moved to a prescribed folder. Let us assume that the data management apparatus 20 has already received a text or image data file from the data file input apparatus 10 and stored it on the HDD 207 (FIG. 2) prior to the execution of this process. Let us also assume that one or more data files to which keywords are assigned are already stored in the destination folder, and that the destination folder and the data files residing therein are also stored on the HDD 207 (FIG. 2).

The user first selects a file to which he wishes to add keywords (step S31). He then decides on a prescribed folder in which the selected file is to be stored, and moves (registers) the file to that folder (step S32).

The CPU 201 of the data management apparatus 20 (FIG. 2) then extracts all keywords from each file that already exists in the folder (step S33). The CPU 201 assigns the extracted keywords to the moved file (step S34). ‘Assign’ here means that if the file that was moved does not have keywords, the extracted keywords are registered in association with the file as its keywords. Where the moved file already has keywords, the extracted keywords are added thereto or are registered in association with the file after the already existing keywords are deleted. The CPU 201 selects either method based on an instruction from the user.

Keywords can be associated with a file by including the keywords in the file or by creating a table that shows the correspondence between the keywords and the file. Where the former method is adopted, the data management apparatus 20 adds the keywords to the file and records them together. The keywords may be added anywhere in the file, such as at the end of the file, for example. Where the latter method is used, the data management apparatus 20 creates a correspondence table separate from the file, and retains such table. An example of such a correspondence table is shown in Table 1.

TABLE 1

| File name | Keyword |
|---|---|
| SC005.bmp | Autumn trip |
| | Day 1 |
| SC007.bmp | Autumn trip |
| | Day 1 |
| | Sand Beach |
| MV003.mpg | Autumn trip |
| | Waves |
| * * * | * * * |

A specific example of the processing performed by the data management apparatus 20 when the correspondence table of Table 1 is used is explained below. Let us assume a situation in which the user wants to move a new file (SC010.bmp) to the folder in which the files having the file names shown in the leftmost column of Table 1 are stored. The CPU 201 extracts all keywords with reference to the correspondence table. In this example, ‘Autumn Trip’, ‘Day 1’, ‘Sand Beach’, ‘Waves’, etc. are extracted. The CPU 201 assigns these keywords to the moved file (SC010.bmp). A revised correspondence table is shown in Table 2.

TABLE 2

| File name | Keyword |
|---|---|
| SC005.bmp | Autumn trip |
| | Day 1 |
| SC007.bmp | Autumn trip |
| | Day 1 |
| | Sand Beach |
| MV003.mpg | Autumn trip |
| | Waves |
| * * * | * * * |
| SC010.bmp | Autumn Trip |
| | Day 1 |
| | Sand Beach |
| | Waves |
| | * * * |

It is very useful to add the keywords for the files that already reside in the folder in this way, because folders are usually used in order to facilitate file management by the user, and the files included in a given file are related to each other in some way.

In the description provided above, all keywords were extracted from all files, but it is also possible to extract keywords from a limited number of types of files or to extract a limited number of keywords. For example, it is also acceptable if keywords are extracted from files that have the same extension as the file that was newly registered. An ‘extension’ is a text string that is added to the file name and shows the nature of the file such as the file format. An extension may be specified each time [file registration is performed] or may be specified in advance. It is also acceptable if keywords are extracted from a prescribed number of files in accordance with the registration data and starting with the file that has been registered most recently, or if the number of keywords to be added is limited. For example, the user can specify that no more than six keywords be added, for example.

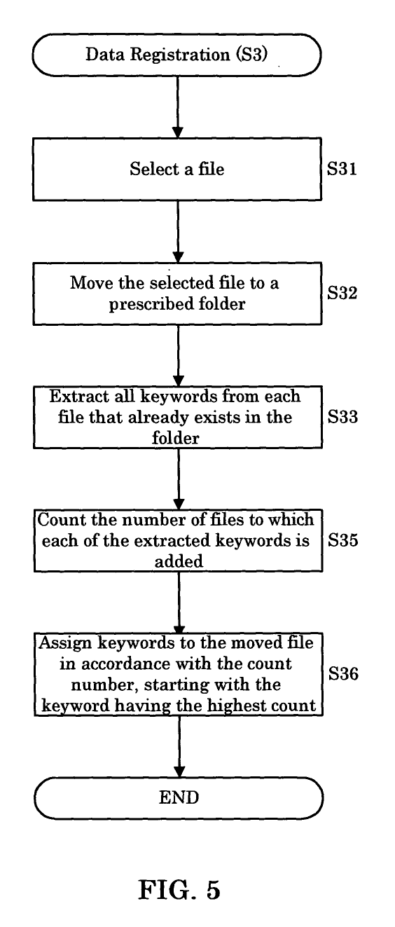

FIG. 5 is a flow chart showing the sequence of data registration in which the keyword extraction routine is different from that described above. Among the processes involved in this routine, steps S31-S33 will not be explained because they were already explained with reference to FIG. 4.

In step S35, the CPU 201 counts the number of files to which each of the extracted keywords is added. For example, using the example of Table 1, because the keyword ‘Autumn Trip’ is added to the three files ‘SC005.bmp’, ‘SC007.bmp’, and ‘MV003.mpg’, the result of this counting is ‘three’. The keyword ‘Day 1’ is added to the two files ‘SC005.bmp’ and ‘SC007.bmp’. Therefore, the result of this counting is ‘two’. In step S36, an appropriate number of keywords is assigned to the moved file (SC010.bmp) in accordance with the count number, starting with the keyword having the highest count. Through this operation, keywords that are added to at least two files and therefore are relatively more important are automatically assigned to the target file.

The number of keywords that may be assigned to a file may be determined by the user. It is acceptable, however, if all keywords are added to the file where the keyword count exceeds the specified number.

The data management apparatus 20 that can automatically assign keywords to a file was described above. Because keywords are automatically assigned to a file, the user is not burdened by the need to perform extra operations and can effectively carry out file management. It is also possible to display on the CRT 203 (FIG. 2) the keywords eligible to be automatically assigned, such that the user can select the keywords to assign.

The data management apparatus 20 operates in accordance with a computer program based on the flow charts of FIGS. 3-5. Such a computer program is recorded on a recording medium comprising an optical disk such as a CD or DVD, a magnetic disk such as a floppy disk, or a semiconductor memory such as Smart Media or Compact Flash® media. It may be transmitted to another computer via an electric communication circuit such as the Internet, and recorded on a recording medium such as the memory of the receiving computer.

Using an embodiment as described above, keywords corresponding to keywords added to the files in a folder are automatically assigned to a new file. Therefore, the user is freed from the burden of selecting keywords and entering them for association with the file. In addition, because keywords are assigned to all files, file management can be made more effective.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. A data management apparatus that manages data files, comprising:
a storage unit that stores folders, data files and keywords assigned to each data file;
an input unit by which the user enters an instruction to move a new data file to a folder; and
a processing unit that extracts the keywords assigned to the existing data files in that folder and assigns them to the new data file in response to the instruction.

2. A data management apparatus according to claim 1, wherein a name of the data file includes an extension showing the nature of the file.

3. A data management apparatus according to claim 2, wherein said processing unit extracts keywords only from existing data files having the same extension as the new data file.

4. A data management apparatus according to claim 1, wherein said processing unit counts the number of files to which each of the extracted keywords is added

5. A data management apparatus according to claim 4, wherein said processing unit assigns keywords to the new data file in accordance with the count number, starting with the keyword having the highest count.

6. A data management apparatus according to claim 1, wherein said processing unit adds the keywords extracted from the existing data files to the keywords which are already assigned to the new data files.

7. A data management apparatus according to claim 1, wherein said processing unit assigns the keywords extracted from the existing data files to the new data file after deleting the keywords which are already assigned to the new data file.

8. A data management apparatus according to claim 1, wherein said processing unit selects whether or not the keywords which are already assigned to the new data file are deleted on the basis of the instruction inputted by said input unit.

9. A data management apparatus according to claim 1 further comprising an interface that receives the new data file.

10. A data management method that manages data files, comprising the steps of:
storing an new data file in a storage unit;
receiving an instruction to move the new data file to a folder;
extracting the keywords assigned to the existing data files in that folder in response to the instruction; and
assigning the extracted keywords to the new data file.

11. A computer program product comprising:
a computer-readable medium; and
computer program contained on said computer-readable medium for performing the steps of:
storing an new data file in a storage unit,
receiving an instruction to move the new data file to a folder,
extracting the keywords assigned to the existing data files in that folder in response to the instruction, and
assigning the extracted keywords to the new data file.
